(19) United States
(12) Patent Application Publication
(10) Pub. No.: US 2005/0196623 A1
(43) Pub. Date: Sep. 8, 2005

(54) Solar control coated glass composition

(76) Inventor: Clem Steffler McKown JR., Upper Uwchlan, PA (US)

Correspondence Address: Arkema Inc.;26th Flr., 2000 Market Street, Philadelphia, PA, 19103, US

(21) Appl. No.: 11/054,902

(22) Filed: Feb. 10, 2005

Related U.S. Application Data
(60) Provisional application No. 60/549,574, filed on Mar. 3, 2004.

(51) Int. Cl. B32B 15/00

(52) U.S. Cl. 428/432

(57) ABSTRACT

A solar-control transparent substrate composition is presented having a transparent substrate; a first solar heat absorbing interlayer having a high refractive index; a second interlayer having a low refractive index; and a low emissivity layer; where the combined optical thickness of the first and second interlayers is about ⅙^{th} of a 550 nm design wavelength. Also provided is a method of producing the improved, coated, solar-controlled transparent substrate. The solar-control transparent substrate composition eliminates the need for a separate solar absorbing layer, resulting in a thinner, more economical construction with reduced haze. It is especially useful with glass substrates.

### REFERENCE TO RELATED APPLICATION

This application claims the benefit of U.S. Provisional Application Ser. No. 60/549,574, filed Mar. 3, 2004.

### FIELD OF THE INVENTION

This invention relates to a solar control coated transparent substrate having solar control, low emissivity and non-iridescent properties. The coated article comprises a transparent substrate, a low emissivity metal oxide layer and a layer positioned between the substrate and the low emissivity layer which provides both solar heat absorbing and anti-iridescent functions. The heat absorbing and anti-iridescent layer comprises a first interlayer which has a relatively high refractive index and comprises a solar absorbing material and a second interlayer having a relatively low refractive index positioned adjacent to the low emissivity layer. The combined optical thickness of the first and second interlayers are about ⅙^{th} of a 550 nm design. This construction eliminates the need for a separate solar absorbing layer, resulting in a thinner, more economical coating having reduced haze.

### BACKGROUND OF THE INVENTION

A variety of pyrolytic solar control, low emissivity coatings are known. In general, these combine a solar absorbing layer with an infrared reflective (Low E) layer.

Solar-control is a term describing the property of regulating the amount of solar heat energy which is allowed to pass through a window into an enclosed space such as a building or an automobile interior. Low emissivity is a term describing the property of an article's surface wherein the absorption and emission of mid-range infrared radiation is suppressed, making the surface a mid-range infrared reflector and thereby reducing heat flux through the article by attenuating the radiative component of heat transfer to and from the low emissivity surface (sometimes referred to as Low E). By suppressing solar heat gain, building and automobile interiors are kept cooler; allowing a reduction in air conditioning requirements and costs. Windows incorporating low emissivity coatings improve building energy efficiency and comfort during both summer and winter as a result of increased thermal insulating performance. By combining solar control and low emissivity into the same article and by glazing the low emissivity coating at the #2 surface of the window (the second surface from the exterior surface of the window), absorbed solar heat is reradiated preferentially towards the exterior, providing improved solar heat gain reduction.

The demand for high-performance solar control glazing is growing rapidly. Important attributes for commercial acceptance are, energy performance, manufacturing economics, neutral color, low haze, product durability and shelf life.

As explained below, various technologies have been employed to meet the requirement for solar-control and low emissivity glass, however, no one system has successfully met all of the performance requirements in an economic manner.

The deposition of thin transparent coatings onto a transparent substrate having a different refractive index than that of the coating generally results in interference colors (iridescence) which are visible in reflectance. Iridescence is objectionable in most glazing applications. Such iridescence can, in some cases, be minimized or eliminated by placing an anti-iridescence layer between the glass substrate and the first coating. The use of an interference layer between the glass and a subsequent functional layer or layers to suppress iridescence or color reflection was first demonstrated by Roy G. Gordon, and was the subject of U.S. Pat. No. 4,187,336, issued Feb. 5, 1980. The Gordon technology has been the state of the art for coated solar control glass as evidenced by recently issued U.S. Pat. No. 5,780,149 (McCurdy el al, Jul. 14, 1998) which applied two layers to obtain solar control on top of a Gordon type interference layer. The interference layer frequently contains silicon dioxide.

Mochel (U.S. Pat. No. 2,564,708) discloses infrared reflective coatings on glass, including antimony-doped tin oxide. These coatings are produced by spray pyrolysis.

Johnson (U.S. Pat. No. 3,149,989) first combines a solar absorbing layer with a low emissivity layer to produce radiation reflecting (solar control) glass. At least two coatings are used with the first coating, adhered to the glass substrate, being comprised of tin oxide doped with a relatively high level of antimony (a solar absorbing layer). The second coating is also comprised of tin oxide doped with a relatively low level of antimony (an infrared reflecting layer). The two films may be superimposed, one on another, or may be applied to opposite sides of the glass substrate. The contemplated application is solar control window glazing.

Dates et al. (U.S. Pat. No. 3,331,702) teaches the chemical vapor deposition method of forming an antimony-doped tin oxide coating on glass. Dates (U.S. Pat. No. 3,473,944) further describes a coated article having two layers of antimony-doped tin oxide formed either by chemical vapor deposition or by spray pyrolysis on opposites surfaces of a piece of glass. These two layers have different concentrations of antimony and tin, one layer having a relatively high level of antimony (a solar absorbing layer) and the other layer having a relatively low level of antimony (a low emissivity layer).

Fluorine-doped tin oxide is known to be superior to antimony-doped tin oxide as a low emissivity material and as a transparent conductor, and has therefore largely replaced antimony-doped tin oxide for these purposes. For an equivalent thickness, fluorine-doped tin oxide is capable of lower emissivity and lower sheet resistance. Lytle et al. (U.S. Pat. No. 2,614,944) teaches the formation of fluorine-doped tin oxide by spray pyrolysis. Gordon (U.S. Pat. No. 4,146,657) teaches the chemical vapor deposition of high-quality fluorine-doped tin oxide coatings on glass. Chemical vapor deposition is today the preferred method for producing fluorine-doped tin oxide coatings commercially.

Griest (U.S. Pat. No. 4,286,009) combines an antimony-doped tin oxide solar absorbing layer with a fluorine-doped tin low emissivity layer in a heat absorbing glass article designed to convert incident solar radiation into heat energy that is transferred through the glass to a working fluid for heat transfer. Accordingly, the coated glass absorbs at least 85% of the solar wavelength radiation and has relatively low emissivity characteristic of less than 0.2. Also consistent with its function as a solar collector, the coating is on the outside surface of the glass (facing the sun), while the heat transfer fluid is in contact with the inside surface of the glass. The construction of said solar collector comprising: a smooth absorber substrate in contact with a heat transfer medium; a solar radiation absorbing metal oxide deposited on the substrate. This metal oxide is selected from the group consisting of antimony doped tin oxide, tin doped indium oxide and iron oxide; and a second coating of infrared reflecting metal oxide. This metal oxide selected from the group consisting of antimony doped tin oxide, fluorine doped tin oxide and tin doped indium oxide. No control over of reflected color is taught.

Anti-iridescence (a neutral-colored specular reflectance) is generally desirable for architectural coatings. Gordon (U.S. Pat. No. 4,187,336) describes several non-iridescent glass structures suitable for producing low emissivity coatings having little or no reflected color. All of the non-iridescent structures taught in these patents comprise: a glass substrate; an iridescence suppressing layer or layers deposited between the glass substrate and the low emissivity layer; and an infrared reflective transparent semiconductor coating (fluorine-doped tin oxide is disclosed) Gordon also teaches that an amorphous, iridescence suppressing layer reduces haze.

In U.S. Pat. No. 4,377,613, Gordon describes an improved non-iridescent glass structure: A) a transparent substrate; B) an infrared reflective coating; and C) an iridescence suppressing layer between said substrate and infrared reflective coating. The iridescence suppressing layer consists of a first interlayer of relatively high refractive index material nearer to the substrate and a second interlayer of relatively low refractive index over the first interlayer. The combined thickness of the iridescence suppressing layer having an optical thickness of about ⅙^{th} of a 500 nm design wavelength. Tin oxide-based infrared reflective and first interlayer layers are taught. The incorporation of solar absorbing coatings into the non-iridescent structure is not contemplated. The inclusion of solar absorbing materials, such as antimony tin oxide, is not disclosed.

Russo et al. (U.S. Pat. No. 4,601,917) teaches a liquid coating composition for producing high-quality, high-performance, fluorine-doped tin oxide coatings by chemical vapor deposition.

Russo et al. (U.S. Pat. No. 5,401,305) teaches a method of depositing amorphous coatings on glass by chemical vapor deposition comprising SnO₂ and SiO₂ and having controllable refractive index.

McCurdy et al. (U.S. Pat. No. 5,780,149) describes solar control coated glass wherein at least three coatings layers are present, first and second transparent coatings and an iridescence suppressing layer lying between the glass substrate and the transparent layers. The invention relies upon the transparent layers having a difference in refractive indices in the near infrared region greater than the difference in indices in the visible region. This difference causes solar heat to be reflected in the near infrared region as opposed to being absorbed. Doped metal oxides, which have low emissivity properties, such as fluorine-doped tin oxide, are used as the first transparent layer. Metal oxides, such as undoped tin oxide are used as the second layer. No NIR absorbing combinations are described.

Hannotiau et al. (GB 2,302,102 A) claims a glazing panel comprising a vitreous substrate carrying a tin/antimony oxide coating layer containing tin and antimony in a Sb/Sn molar ratio of from 0.01 and 0.5, the said coating layer having been pyrolytically formed by chemical vapor deposition, whereby the so-coated substrate solar factor (FS) of less than 70%. An intermediate haze-reducing layer may be placed between the substrate and the tin/antimony oxide layer. Said haze-reducing layer may comprise silicon oxide.

Terneu et al. (U.S. Pat. No. 6,231,971) describes a glazing panel having a solar factor of less than 70%, comprising: a sheet of glass; and at least two coating layers provided on the sheet of glass including the first and second coating layers, the first coating layer comprising tin and antimony oxides and having a Sb/Sn molar ratio ranging from 0.01 to 0.5 and being one of (A) pyrolytically formed from reactants in a gaseous phase or (B) pyrolytically spray formed, and the second coating layer comprising tin oxide doped with fluorine. An intermediate layer is also described, which may be included into the above structure in a position between the glass and the first coating layer. This intermediate layer may consist essentially of silicon and oxygen. Terneu teaches that this intermediate layer is useful to reduce haze. Anti-iridescence is not a part of this invention.

Gallego et al. (U.S. Pat. No. 6,048,621) describes a high performance solar control glass comprising a glass substrate with a coating comprising a heat absorbing layer and a low emissivity layer of a metal compound, wherein the low emissivity layer of the coating overlies the heat absorbing layer, and wherein the low emissivity layer has a thickness in the range 100 nm to 600 nm and wherein the coated glass has an emissivity of less than 0.4. Since the thin film produced may result in the appearance of interference colors and iridescence, an iridescence suppressing layer or layers between the glass and the heat absorbing layer may be used.

McKown, et al. (U.S. Pat. No. 6,218,018) teaches a coated, solar control glass having preselected reflected color and having a NIR solar absorbing layer and a low emissivity layer, without the need for a Gordon type underlayer. The construction comprises glass having a SnO₂ coating containing at least two layers with one layer being a solar absorbing layer comprising SnO₂ containing a dopant selected from the group consisting of antimony, tungsten, vanadium, iron, chromium, molybdenum, niobium, cobalt, nickel and mixtures thereof and another layer being a low emissivity layer comprising SnO₂ containing a dopant selected from the group fluorine, phosphorous and mixtures thereof. Reflected color can be selected, including neutral reflected color, by the order, thickness and dopant type and level without the need for a separate iridescence suppressing layer. The constructions taught by McKown, et al. are not readily able to produce coatings which have both neutral reflected color and visible transmittances greater than 70%.

Russo, et al. (U.S. Pat. No. 6,596,398) expands on the teachings of U.S. Pat. No. 6,218,018 including the addition of an additional layer either between the glass and the SnO₂ coating, or above the SnO₂ coating.

Unfortunately, solar control coatings of the present art produces solar control coatings by stacking heat absorbing and low emissivity layers. Both of these layers are typically crystalline. The combined thicknesses of these two layers either leads to coatings having relatively high levels of haze or limited performance, for example a relatively high emissivity.

The stacking of heat absorbing and low emissivity layers produces coatings which are thicker overall than low emissivity coatings having comparable performance (emissivity). These thicker coatings are both more difficult to produce because of the additional layer and increased thickness and more expensive to produce.

There is further a need for a solar control coating capable of having a relatively high visible transmittance, preferably about or greater than 70%, and neutral reflected color with little or no haze.

Surprisingly it has been found that by incorporating the solar absorbing layer into the functional iridescence suppressing interlayer, the need for a separate solar absorbing layer is eliminated. In combining the functions of these layers, a simpler, thinner, more manufacturable and more economical coating is achieved. The thinner construction and ability to incorporate an amorphous second interlayer provides excellent haze control. Iridescence suppression at visible transmittances of about 70% and higher is practical.

### SUMMARY OF THE INVENTION

It is an object of the invention to obtain a solar control coated glass or other transparent substrate capable of having a relatively high level of visible light transmittance and neutral transmitted and reflected color.

It is a further object of the invention to provide a solar control glass having low haze and high energy efficiency performance.

Another object of the invention is to eliminate the need for separate solar absorbing and iridescent suppressing layers, thereby producing a thinner, more economical coating

The objectives of the invention are achieved, in accordance with the principles of a preferred embodiment of the invention, by a coated solar control transparent substrate composition having a neutral reflected color comprising the following layers:
a) a transparent substrate;
b) a first interlayer having a relatively high refractive index and comprising a solar heat absorbing material;
c) a second interlayer having a relatively low refractive index;
d) a low emissivity layer;
wherein the combined thickness of the first and second interlayers is about ⅙^{th} of a 550 nm design wavelength.

### BRIEF DESCRIPTION OF THE DRAWINGS

FIG. 1 depicts a cross-section of coated glass having at least three different layers or films in different stacking sequences on a glass substrate.

### DETAILED DESCRIPTION OF THE INVENTION

The solar control coated transparent substrate composition of the present invention contains at least three distinct layers, in order from the substrate outward: a first interlayer, a second interlayer, and a low-emissivity layer. The coated substrate composition is produced by depositing the layers sequentially on a heated transparent substrate. Additional optional layers may also be present in the composition.

Energy efficiency properties applied to windows are typically expressed in terms of total solar energy transmittance (g) and thermal transmittance (U).

The first interlayer is a solar absorbing layer having a relatively high refractive index. The refractive index is in the range of 1.70 and 2.00, preferably between 1.75 and 1.90, and most preferably between 1.75 and 1.85.

The solar absorbing layer is composed of SnO₂ containing a dopant. The dopant is preferably antimony although the dopant can be any element selected from the group consisting of antimony, tungsten, vanadium, iron, chromium, molybdenum, niobium, cobalt, nickel, and mixtures thereof.

The optical thickness of the solar absorbing interlayer is in the range of 15 to 70 nm, preferably about 1/12^{th} of a design wavelength of 550 nm. The 550 nm design wavelength corresponds to human eye sensitivity maxima.

The second interlayer has a lower refractive index than the first interlayer, preferably in the range of 1.46 to 1.70, more preferably in the range of 1.50 to 1.70 and most preferably in the range of 1.60 to 1.70. The second interlayer may contain inorganic compounds of silicon, aluminum, tin, phosphorous, boron and mixtures thereof. While compounds such as SiO₂ are useful, a preferred second interlayer is an amorphous mixture comprising silicon and tin oxides. The use of an amorphous second interlayer provides superior haze control in comparison to a crystalline second interlayer. The optical thickness of the second interlayer is in the range of 15 to 70 nm.

The second interlayer is directly deposited on the first interlayer, with the first interlayer being closest to the transparent substrate. The two interlayers have a combined optical thickness of about ⅙^{th} of a design wavelength of 550 nm. Preferred range=30 to 140 nm. The combination of the first and second interlayers provides an anti-iridescence property to the composition, that neither layer alone provides. The thickness and refractive indexes of the interlayers are selected to yield a reflected color saturation of less than 12, more preferably less than 8, and most preferably less than 5.

The low emissivity layer is similar to that taught in U.S. Pat. No. 6,218,018, incorporated herein by reference. The low emissivity layer is one having an emissivity of less than 0.4, and preferably an emissivity of less than 0.2. The low emissivity layer must contain a low emissivity dopant that imparts significant conductivity to the layer such as fluorine or phosphorous, although other dopants may be used in combination with the low emissivity dopant. In a preferred embodiment, the low emissivity layer is selected from fluorine-doped tin oxide, antimony-doped tin oxide, phosphorous-doped tin oxide, tin-doped indium oxide, and fluorine-doped zinc oxide. Fluorine-doped tin oxide is especially preferred.

The low-emissivity layer can be composed of a single layer, or may be a composite of several layers, such as for instance a fluorine-doped tin oxide layer and an antimony-doped tin oxide layer. The layers in any multi-layer low-emissivity layer can be stacked in any order

The low emissivity layer preferably has a thickness of between 150 and 450 nm, and more preferably between 250-350 nm.

In a preferred embodiment, the low emissivity layer is directly coated on the second interlayer.

In addition to the first and second interlayers, and the low emissivity layer, it is contemplated that the solar control glass composition may optionally contain one or more other layers. These optional layers may be present as undercoating layers, or they may be in other positions in the stacked composition. Optional layers that may be present include, but are not limited to, an amorphous layer of a mixture of tin and silicon oxides; or silicon oxide.

In a preferred embodiment, no optional layers are present.

The transparent substrate of the invention may be any clear, structural substrate, upon which a coating can be placed. This includes, but is not limited to, glasses and structural plastics. In one preferred embodiment, the glass is a soda lime silica glass.

The coated transparent substrate of the invention has a neutral reflected and transmitted (when deposited on a colorless substrate) color, so that (a*²+b*²)^{1/2} is less than 12, preferably less than 8 and more preferably less than 5.

The coated article is produced by depositing the layers sequentially on a heated transparent substrate, by means known in the art such as spray pyrolysis or CVD methods. Spray pyrolysis is known and disclosed in patents such as U.S. Pat. No. 4,349,370 (Terneu). CVD methods for depositing SnO₂ films with or without dopants and the chemical precursors for forming SnO₂ films containing dopants are well known and disclosed in U.S. Pat. Nos. 3,331,702, 4,601,917, and 4,265,974. The preferred method is CVD of the doped SnO₂ layers according to known methods directly onto the float glass ribbon either immediately outside of or within the float bath chamber. CVD of doped tin oxide within the float bath chamber is taught by U.S. Pat. No. 4,853,257 (Henery). The process is very amenable to existing commercial on-line deposition systems.

Water is preferably used to accelerate the deposition of SnO₂ coatings onto glass as taught by U.S. Pat. No. 4,590,096 (Lindner) and used in concentrations from ˜0.75 to 12.0 mol % based on tin precursor concentrations and deposition rates required.

The coatings function by a combination of reflection and absorption. The low emissivity film reflects mid-IR heat in the 2.5-25 micron region of the spectrum while the solar absorbing first interlayer absorbs heat primarily in the 750-2500 nm region. The second interlayer, in combination with the first interlayer, provides anti-iridescence properties via destructive interference.

Precursors for the dopant in the solar absorbing layer (antimony, tungsten, vanadium, iron, chromium, molybdenum, niobium, cobalt and nickel) are preferably metal halides such as antimony trichloride, however metal alkoxides, esters, acetylacetonates and carbonyls which are sufficiently volatile and reactive can be used as well. Other suitable precursors for the dopant and SnO₂ are well known to those skilled in the art. Dopant precursors which are solid, such as antimony trichloride, may be more easily used by first dissolving them into a liquid tin precursor to form a liquid solution. The resulting liquid solution can then be readily stored, pumped, metered by process flow control devices and vaporized.

Silicon oxide coatings can be produced from silane. The deposition of amorphous mixed tin and silicon oxide coatings from monobutyltintrichloride, a silica precursor such as tetraethylorthosilicate, and an accelerant such as triethylphosphite is taught in U.S. Pat. No. 5,401,305.

Suitable precursors and quantities for the fluorine dopant in the low emissivity SnO₂ layer are disclosed in U.S. Pat. No. 4,601,917 and include trifluoroacetic acid, ethyltrifluoroacetate, ammonium fluoride (spray pyrolysis only), and hydrofluoric acid. The molar ratio of fluorine precursor to tin precursor in the CVD vapor feed stream is typically between 0.05:1 and 0.30:1. This generally correlates to a fluorine concentration in the low e film of from 1 to 5 weight percent.

The preferred solar absorbing films can be deposited in a similar fashion as the low emissivity films using such methods as disclosed in U.S. Pat. No. 4,601,917. The organotin precursors for the SnO₂ can be vaporized in air or other suitable carrier gases containing a source of O₂ and in precursor concentrations from 0.25-4.0 mol % (0.5-3.0 mol % more preferred). SnO₂ precursor concentrations are expressed herein as a percentage based upon the moles of precursor and the moles of CVD vapor. The preferred molar ratio of solar absorbing dopant precursor to tin precursor in the CVD vapor feed stream is typically between about 0.02:2 to about 0.35:1 (0.14:1 to 0.35:1 more preferred). Preferred is an antimony dopant using antimony trichloride as the precursor at about 10% to about 22% by weight in monobutyltintrichloride. This correlates to a similar antimony mass percent in the tin oxide film.

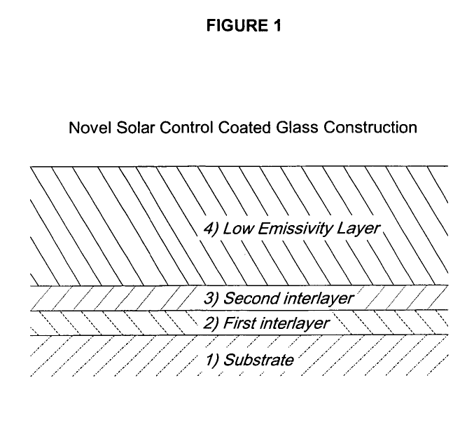

The coated glass of the present invention is depicted in FIG. 1 showing the film in cross section. The film thicknesses can range from 150 to 450 nm for the low emissivity film (4) and with optical thickness of about ⅙^{th} of a 550 nm design wavelength for the first and second interlayers (3 and 4) together.

Another embodiment of this invention is the reduction of film haze. Haze is caused by the scattering of incident light by a rough surface or interface or inclusions or voids within the coating.

1. A coated solar control transparent substrate composition having a neutral reflected color comprising the following layers:
a) a transparent substrate;
b) a solar heat absorbing first interlayer having a relatively high refractive index;
c) a second interlayer having a relatively low refractive index;
d) a low emissivity layer;
wherein the combined optical thickness of the first and second interlayers is about ⅙^{th} of a 550 nm design wavelength.

2. The coated solar control transparent substrate of claim 1 wherein said substrate is soda lime silica glass.

3. The coated solar control transparent substrate of claim 1 wherein said first interlayer has a refractive index of from 1.70 to 2.00.

4. The coated solar control transparent substrate of claim 1 wherein said first interlayer comprises inorganic oxide of tin, antimony, tungsten, vanadium, iron, chromium, molybdenum, niobium, cobalt, nickel and mixtures thereof.

5. The coated solar control transparent substrate of claim 5 wherein said first interlayer comprises doped tin oxide.

6. The coated solar control transparent substrate of claim 1 wherein said first interlayer has an optical thickness of about 1/12^{th} of a design thickness of 550 nm.

7. The coated solar control transparent substrate of claim 1 wherein said second interlayer has a refractive index of from 1.46 to 1.60.

8. The coated solar control transparent substrate of claim 1 wherein said second interlayer comprises inorganic oxides of silicon, aluminum, tin, phosphorous, boron and mixtures thereof.

9. The coated solar control transparent substrate of claim 1 wherein said low emissivity layer has an emissivity of less than 0.4.

10. The coated solar control transparent substrate of claim 10 wherein said low emissivity layer has an emissivity of less than 0.2.

11. The coated solar control transparent substrate of claim 1 wherein said low emissivity layer comprises fluorine-doped tin oxide, antimony-doped tin oxide, phosphorous-doped tin oxide, tin-doped indium oxide or fluorine-doped zinc oxide.

12. The coated solar control transparent substrate of claim 12 wherein said low emissivity layer comprises fluorine-doped tin oxide.

13. The coated solar control transparent substrate of claim 1 wherein said low emissivity layer has a thickness of from 150 to 450 nanometers.

14. The coated solar control transparent substrate of claim 14 wherein said low emissivity layer has a thickness of from 250 to 350 nanometers.

15. The coated solar control transparent substrate of claim 1 wherein the second interlayer comprises an amorphous layer comprising a mixture of tin and silicon oxides.

16. The coated solar control transparent substrate of claim 1 wherein the second interlayer comprises a layer comprising silicon oxycarbide.

17. The coated solar control transparent substrate of claim 1 wherein the second interlayer comprises a layer comprising silicon oxynitride.

18. The coated solar control transparent substrate of claim 1 wherein the second interlayer comprises a layer comprising silicon oxide.

19. A process for producing a coated solar control transparent substrate composition comprising sequentially depositing on a transparent substrate:
a) a first interlayer having a high refractive index;
b) a second interlayer having a low refractive index;
c) a low emissivity layer;
wherein the combined thickness of the first and second interlayers is about ⅙^{th} of a 550 nm design wavelength.
